(19) United States
(12) Patent Application Publication
(10) Pub. No.: US 2005/0192821 A1
(43) Pub. Date: Sep. 1, 2005

(54) Web based electronic waiver requisition

(75) Inventor: Ben Nee Goon, Petaling Jaya (MY)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 10/788,869

(22) Filed: Feb. 27, 2004

(51) Int. Cl. G06F 17/60

(52) U.S. Cl. 705/1; 705/26

(57) ABSTRACT

The present application describes a system and computer readable medium for web-based electronic waiver requests. According to one embodiment, a waiver request database (125) is created in a networked database server (120). The database server (120) can be accessed via a network (130) by various organizations located remotely from each other. A requestor (110) can initiate a waiver request by entering required information into the waiver request database (125). When the requester (110) enters the required information, the database server (120) sends electronic notifications (115) to appropriate authorizing personnel or responders (140). Upon receiving the notification (115), the authorizing personnel (140) can approve/reject the waiver request by entering/selecting data in corresponding fields of the waiver request database.

### TECHNICAL FIELD

The present application describes web-based electronic transactions, and specific embodiments of a system and method for web-based electronic waiver requests.

### BACKGROUND

Generally, business and technical transactions are conducted according to certain predefined business or technical processes. For example, semiconductor devices are tested according to a test specification provided by design organization. Typically, semiconductor device testing is performed by one or more pieces of Automated Test Equipment (“ATE”) that are programmed to test semiconductor devices according to the test specification. The test specification can include a range of expected results for various tests to be performed on semiconductor devices. During the testing, when a test on a device fails to produce results within the range of expected results, the device is rejected as failed and is not shipped to customers.

Some of the failed tests may not represent the functionality of the device under normal operating conditions. For example, manufacturing process variations for the device can cause a variation in an output voltage of a circuit block of the device for a given input voltage. In some applications, however, the variation in output voltage may be tolerable or the input voltage applied in the test and causing the failure may be well outside the actual operating conditions for the device.

In some cases, the ATE can reject an entire lot of devices, which may include thousands of devices. Typically, to ship a device that is rejected by the ATE, a semiconductor device testing organization requires an approval from the design organization and other organizations such as product management, to waive the failed test and authorize to ship the device that otherwise functions properly under normal operating conditions.

In global organizations, where individual departments may be located in various parts of the world, it becomes difficult and time-consuming to coordinate a process for waiving a failed test. Further, in the case of semiconductor device testing, if a waiver is authorized locally at a manufacturing site, then the waiver notification may not be immediately available to other manufacturing sites located around the world and producing the same device. To obtain an approval to waive a process or a portion thereof, a requestor is typically required to fill-out forms and get signatures from all concerned organizations. The cycle time for obtaining signatures from all concerned organizations can be considerably large and in some cases may take days before the final approval for the waiver is received. The delay in obtaining the waiver can create a backlog of products to be shipped and the amount of time required to obtain the final approval can adversely affect productivity.

### SUMMARY

The present application describes a system and method for web-based electronic waiver requests. According to one embodiment, a waiver request database is created in a networked database server. The waiver request database can be a distributed database within a network (Internet or Intranet) and can be accessed via the network by various organizations located remotely from each other. The waiver requests may originate from human or automated testers of incoming components parts in the electrical or mechanical fields, from chemical or line assembly testers, or from people or equipment in the business process field. In any case, the human or automated testers are generally seeking a departure from a specification, where the specification may, for example, set forth certain process or component-piece-part characteristics.

The requester can enter the waiver request information in an electronic waiver request form by accessing the waiver request database via the network. For example, in the case of obtaining a waiver for a test for a semiconductor device, the required information can include device name, device identification, product category, project identification, and similar other information. The requestor can identify personnel/organizations authorized to issue the waiver in the waiver request form, or the database server can retrieve that information from other databases using the device information. The access to the waiver request database can be restricted by requiring a login for authorized users.

According to some embodiments, when the requester enters the required information into the waiver request database, the database server sends electronic notifications (e.g., emails, instant text messages, prerecorded voice pages, or similar other notifications) to appropriate authorizing personnel. Upon receiving the notification, the authorizing personnel can approve/reject the waiver request by entering/selecting data in corresponding fields of the waiver request database. According to one embodiment, when the authorizing personnel approve/reject the waiver request, the database server sends electronic notifications (e.g., emails, instant text messages, prerecorded voice pages, or similar other notifications) to the requestor informing them of the approval/rejection.

According to one embodiment, the electronic notifications can be customized according to the action taken by the authorizing personnel. When more than one authorizing person are identified for a particular waiver request, the database server can be configured to send electronic notifications to the requestor upon receiving an approval/rejection from each authorizing person or send a combined electronic notification upon receiving approval/rejection from all the appropriate authorizing personnel. According to another embodiment, the database server can be configured to send periodic electronic notifications to the requestor and authorizing personnel. In some variations, the database server can be configured to send electronic notifications to other related personnel/organizations that are not involved in the process of requesting/authorizing/rejecting the process waiver such as, other manufacturing sites producing the same device. According to some embodiments, the requester can query the database to determine the status of the waiver request.

The foregoing is a summary and thus contains, by necessity, simplifications, generalizations and omissions of detail; consequently, those skilled in the art will appreciate that the summary is illustrative only and is not intended to be in any way limiting.

### BRIEF DESCRIPTION OF THE DRAWINGS

FIG. 1 illustrates an exemplary web-based electronic waiver request system; and

FIG. 2 is a flowchart illustrating exemplary steps performed by an exemplary electronic waiver request system.

### DETAILED DESCRIPTION OF THE EMBODIMENTS

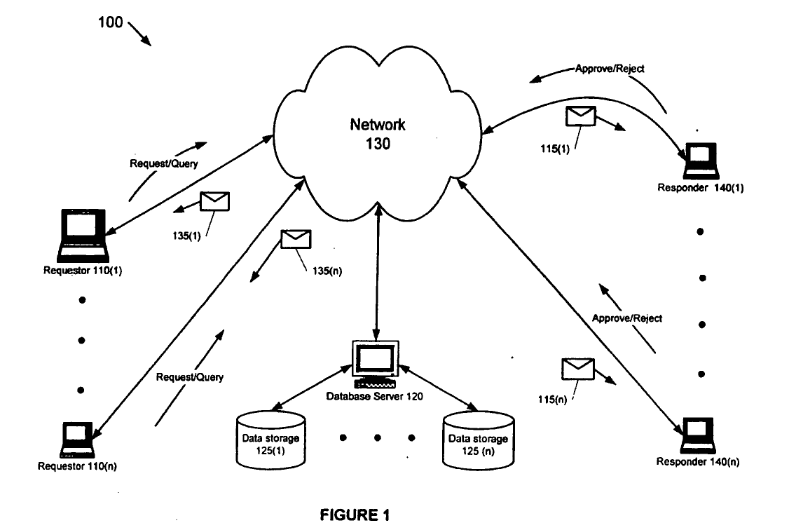

FIG. 1 illustrates an exemplary web-based electronic waiver request system 100. The system 100 includes requestors 110(1)-(n). In the present example, the requestor 110 can be a device tester requiring a waiver for a test during the testing of a semiconductor device. When the requestor 110 requires the waiver for the process, the requestor 110 can access a waiver request database by logging into a waiver database server 120 via a network 130. The network 130 can be any network that can be used to log into the database server 120, such as the Internet or an intranet configured for an organization's internal use. Alternatively, the network 130 can be a combination of one or more intranets and the Internet. Further, various elements of the system 100 can be coupled to the network 130 via wireline connection(s), wireless connection(s), or combinations thereof.

The waiver database server 120 can be any server configured to manage databases over the network 130. In the present example, the database server 120 is coupled to data storage 125(1)-(n). The data storage 125 can be any memory storage element configured to store data. For purposes of illustrations, one database server 120 with data storage 125(1)-(n) is shown; however, the database server 120 can be a distributed database management system including one or more database servers distributed over various sites throughout the network 130. Similarly, the data storage 125 can be located anywhere within the network 130. The access to the database server 120 can be restricted for use by authorized users via various known data security schemes.

When the requestor 110 logs into the database server 120, the requestor 110 can fill out an electronic request form. The electronic request form can require inputting appropriate information about the process or a portion thereof that is to be waived. For example, in the case of the waiver for the test during the testing of the semiconductor device, the request form can require information about the semiconductor device such as, device name, device identification, package type, number of devices affected by the waiver, test identification, process information, and similar other device and test related information. The format of the request form and data fields of the waiver request database can be configured according to a given process waiver application.

Further, the request form can require appropriate information about the requestor and the person/organization responsible for approving/rejecting the waiver. Alternatively, the database server 120 can be configured to retrieve such information from other databases using the requestor's login identification and device information inputted by the requestor. Various known database management schemes can be used to configure the data structure of the database server 120 to make the waiver request database effective and efficient for a given application.

After the requestor 110 inputs the required information into the request form, the database server 120 can issue a request tracking identification to the requestor 110 for database query and record keeping purposes. The database server 120 can be configured to send an electronic notification to appropriate personnel/organizations to inform them about the waiver request and to request an action on the waiver request. The electronic notification can be sent using various communication means. According to one embodiment, the database server 120 sends an email message 115 to appropriate personnel/organizations. The email message 115 can include information about the waiver request. In some embodiments, the database server can send a text message to a computer, a personal digital assistant, a cell phone, or similar message receivers of the person authorized to take an action on the waiver request. In some variations, the database server 120 can send a prerecorded voice page for the authorized person's voice message receiver (e.g., a voice mail). In one embodiment, the requestor 110 can select appropriate notification means in the waiver request form. Further, when multiple persons/organizations are responsible for the waiver request, the database server 120 can be configured to send notifications to all identified personnel/organizations. The notifications can be sent periodically according to an interval selected by the requestor 110.

The system 100 includes responders 140(1)-(n). The responder 140 can be any person/organization authorized to approve/reject a waiver request. Upon receiving the notification, a responder 140 who is authorized to act on the waiver request, can review the waiver request by logging into the database server 120. The responder 140 can also review data related to the waiver request. For example, for the waiver of a particular test of the semiconductor device, the database server 120 can be configured to access a test database so that the responder 140 can review the test history of the particular test for the semiconductor device before taking an action on the waiver request. The waiver request database can be configured to provide predetermined options for the responder 140. For example, the waiver request form can provide menu selections for the responder 140 to choose an option for approving or rejecting the waiver request. Further, the waiver request database can be configured to allow the responder 140 to input additional comments into the waiver request form.

After reviewing the waiver request, the responder 140 can either approve or reject the waiver request by inputting/selecting appropriate information in/from the waiver request form. When the responder 140 takes an action on the waiver request, the database server 120 determines whether additional authorizations from other personnel/organizations are required. If additional authorizations are required, then the database server 120 can either wait for a predetermined period to receive additional authorizations or resend electronic notifications to the other personnel/organizations.

Upon receiving appropriate actions from the responders 140, the database 120 can send an electronic notification 135 to the requestor 110 informing the completion of the waiver request process. The notification can be in any form described above. Upon receiving the electronic notification 135, the requestor 110 can take appropriate actions. In one embodiment, the requestor 110 can log into the database 120 to query the status of the waiver request using the tacking identification issued by the database server 120. Further, the requestor 110 can also cancel the waiver request. In the case of a cancellation of the waiver request, the database server 120 can send appropriate notifications to personnel/organizations authorized to take actions on the waiver request.

One skilled in art will appreciate that the responder 140 can take various actions on the waiver request. For example, upon receiving a notification such as an email, the responder 140 can send a return email to the database 120 with appropriate message (e.g., approved/rejected) without logging into the database 120. Similarly, instead of authorizing or rejecting a waiver request, the responder 140 can request a ‘hold’ of the waiver request to discuss the waiver request with the requestor 110 or other personnel/organizations before taking an action on the waiver request. The responder 140 can also request additional information regarding the waiver request from the requestor 110. If the responder 140 needs additional information, then the responder 140 can log into the database 120 and enter request for additional information into the request form. When the responder 140 enters the request for additional information, the database server 120 can send notifications to the requestor 110 requesting additional information. Upon receiving the notification for additional information, the requestor 110 can enter the requested information into the waiver request form and resubmit the waiver request.

In some embodiments, the requestor 110 can be ATE. For example, the ATE can be configured to test a particular semiconductor device and when results of one or more tests differ from predetermined test results, the ATE can automatically send a waiver request to the database server 120 including the device information. Upon receiving the waiver request, the database server 120 can retrieve data related to the particular semiconductor device from a device database and send notifications to appropriate personnel/organizations identified in the device database for that particular device. In some variations, the device database can be integrated into the database server 120.

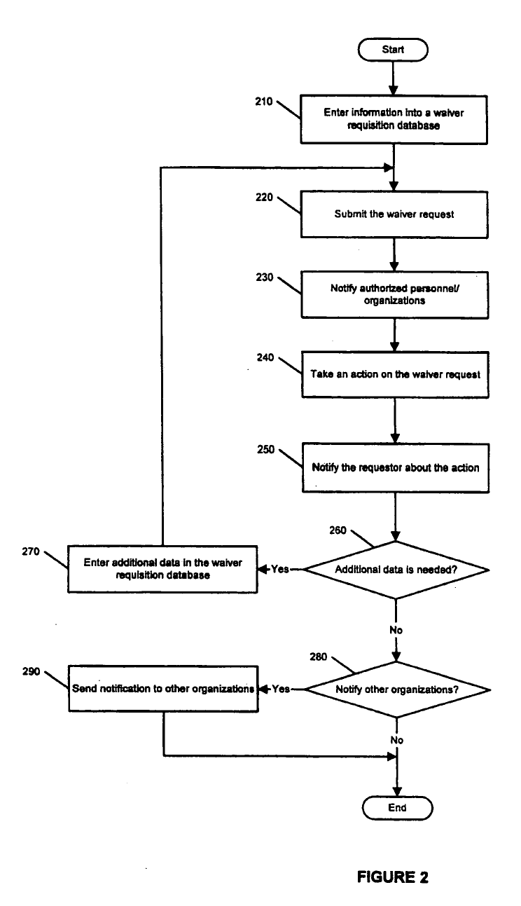

FIG. 2 is a flowchart illustrating exemplary sequence of steps performed by an exemplary web-based electronic waiver request system. Initially, a requestor enters information into a waiver request database about a process that is to be waived for example, information about a particular test of a semiconductor device 210. The requestor then submits the waiver request for approval 220. Upon receiving the waiver request, the waiver request database notifies one or more responders authorized to take an action on the waiver request using various electronic notification means described above 230. When the responder receives the notification, the responder can take various actions such as, approve, reject, or put a hold on the waiver request 240.

When the responder takes an action on the waiver request, the waiver database server notifies the requestor about the action 250. The responder can also request additional information before taking a final action on the waiver request. A determination is made whether the responder has requested additional information about the waiver request 260. If the responder has requested additional information, the requestor can input additional data into the waiver request database 270. The requester can then resubmit the waiver request 220. If the additional information is not requested, then a determination is made whether other organizations need to be notified about the waiver request 280. In the case of semiconductor device testing, if a particular device is being manufactured at multiple locations, then a waiver request for a test for that particular device from one location can be communicated to other manufacturing locations. If other organizations are to be notified, then the waiver request database server sends appropriate notifications to those organizations 290. Alternatively, the waiver request database can notify other organizations when the responder submits the initial waiver request. The waiver request database can also be configured to inform other organizations at any stage of the process. The waiver request database can be further configured to provide an option for other manufacturing sites to input additional data into the waiver request. One skilled in art will appreciate that various known database schemes can be used to configure the waiver request database for a given application.

For purposes of illustration, a particular application (e.g., semiconductor testing) is described for the web-based electronic waiver request process; however, the system and method described herein can be implemented for numerous applications. For example, in financial organizations, the web-based waiver request process can be used to request waivers for certain document requirements in a financial transaction. Similarly, the web-based waiver request process can be used to obtain decisions from various remotely located organizations on various business processes.

A few preferred embodiments have been described in detail herein. It is to be understood that the scope of the invention also comprehends embodiments different from those described, yet within the scope of the claims. Words of inclusion are to be interpreted as nonexhaustive in considering the scope of the invention. While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

The section headings in this application are provided for consistency with the parts of an application suggested under 37 CFR 1.77 or otherwise to provide organizational cues. These headings shall not limit or characterize the invention(s) set out in any patent claims that may issue from this application. Specifically and by way of example, although the headings refer to a “Field of the Invention,” the claims should not be limited by the language chosen under this heading to describe the so-called field of the invention. Further, a description of a technology in the “Description of Related Art” is not be construed as an admission that technology is prior art to the present application. Neither is the “Summary of the Invention” to be considered as a characterization of the invention(s) set forth in the claims to this application. Further, the reference in these headings to “Invention” in the singular should not be used to argue that there is a single point of novelty claimed in this application. Multiple inventions may be set forth according to the limitations of the multiple claims associated with this patent specification, and the claims accordingly define the invention(s) that are protected thereby. In all instances, the scope of the claims shall be considered on their merits in light of the specification but should not be constrained by the headings included in this application.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method for processing specification waiver requests over a network connecting a waiver requestor to a plurality of responders relative to a specification having a plurality of elements, the method comprising:
providing a waiver request database that is operable to store a plurality of waiver requests from the waiver requester;
receiving at the waiver request database a waiver request from the requester, the request seeking a waiver of at least one of the specification elements from at least one of the plurality of responders;
sending a notification from the waiver request database to the plurality of responders, seeking the requested waiver of the at least one specification element; and
transmitting data from the waiver request database to the requestor, whereby the requester may determine whether the waiver request has been approved by at least one of the plurality of responders.

2. A method according to claim 1, and further comprising receiving in the waiver request database another waiver request from another waiver requestor.

3. A method according to claim 2, wherein the waiver request database sends another notification seeking the other waiver request received from the other waiver requester.

4. A method according to claim 3, wherein the other notification is sent to another plurality of responders.

5. A method according to claim 3, wherein the other notification is sent to the same plurality of responders as the original notification.

6. A method according to claim 1, and further comprising receiving at least one response to the notification from the plurality of responders.

7. A method according to claim 6, further comprising, if the at least one response is a request for additional information about the waiver request:
notifying the requestor about the request for additional information;
receiving additional information from the requestor; and
notifying the plurality of responders about the additional information.

8. A method according to claim 7, further comprising receiving a second response from the plurality of responders.

9. A method according to claim 6, wherein the at least one response is selected from the group consisting of: approving the waiver request; rejecting the waiver request; requesting to hold the waiver request; and requesting additional information about the waiver request.

10. A method according to claim 1, further comprising generating a database entry corresponding to each waiver request in the waiver request database.

11. A method according to claim 10, wherein the waiver request database is a distributed database comprising one or more database servers distributed over one or more networks.

12. A method according to claim 1, wherein the sending the notification comprises an action selected from the group consisting of: sending an e-mail; sending an instant text message;
and sending a prerecorded voice message.

13. A method according to claim 1, wherein the sending of the notification is repeated for a certain period of time or until a certain number of responses are received from the plurality of responders.

14. A method according to claim 1, wherein the waiver request is for the waiver of at least one test corresponding to the at least one of the specification elements.

15. A computer readable medium carrying one or more sequences of instructions for web-based processing of a waiver request, the one or more sequences of instructions are configured for:
providing a waiver request database that is operable to store a plurality of waiver requests from the waiver requester;
receiving at the waiver request database a waiver request from the requestor, the request seeking a waiver of at least one of the specification elements from at least one of the plurality of responders;
sending a notification from the waiver request database to the plurality of responders, seeking the requested waiver of the at least one specification element; and
transmitting data from the waiver request database to the requestor, whereby the requestor may determine whether the waiver request has been approved by at least one of the plurality of responders.

16. A computer readable medium according to claim 15, wherein the one or more sequences of instructions are further configured for:
notifying the requestor about the request for additional information;
receiving additional information from the requester; and notifying the plurality of responders about the additional information.

17. A web-based process waiver request system comprising:
a waiver request database server;
at least one requestor computing system coupled to the waiver request database server;
at least one responder computing system coupled to the waiver request database server,
wherein the waiver request database server is configured to:
receive a waiver request from a requestor for at least one responder to waive at least one step of a process;
notify the at least one responder about the waiver request to respond to the waiver request; and
receive a first response from the at least one responder.

18. A system according to claim 17, wherein the waiver request database server is further configured, if the first response is a request for additional information about the waiver request, to:
notify the requestor about the request for additional information;
receive additional information from the requestor;
notify the at least one responder about the additional information; and
receive a second response from the at least one responder.

19. A system according to claim 18, wherein the first and second responses include an action by the at least one responder, wherein the action is selected from the group consisting of:
approving the waiver request, rejecting the waiver request, requesting to hold the waiver request;
and requesting additional information about the waiver request.

20. A system according to claim 19, wherein the waiver request database server is a distributed database server comprising one or more servers distributed over one or more networks.
